(19) United States
(12) Patent Application Publication
(10) Pub. No.: US 2006/0278385 A1
(43) Pub. Date: Dec. 14, 2006

(54) Air conditioning system and method for regulating the heating capacity thereof

(75) Inventors: Volker Kirschner, Muhlacker (DE); Andreas Liermann, Limburgerhof (DE)

Correspondence Address: FOLEY AND LARDNER LLP;SUITE 500, 3000 K STREET NW, WASHINGTON, DC, 20007, US

(73) Assignee: BEHR GMBH & CO. KG

(21) Appl. No.: 10/567,334

(22) PCT Filed: Aug. 4, 2004
(86) PCT No.: PCT/EP04/08730

§ 371 Date: Feb. 6, 2006

(30) Foreign Application Priority Data
Aug. 11, 2003 (DE) 103 37 136.2

(51) Int. Cl. B60H 1/00; G05D 15/00; G05D 23/00; G05D 16/00; F25B 49/00; F25B 1/00

(52) U.S. Cl. 165/279; 165/202; 165/281; 165/287; 62/228.1

(57) ABSTRACT

The invention relates to an air conditioning system, especially a motor vehicle air conditioning system, that can be operated as a heat pump. Said system comprises a compressor (2), a heating body (3), a throttle element (4), and an evaporator (6), the compressor (2) having a variable stroke. The throttle element (4) is especially embodied as a controllable expansion valve (5) that contributes to the regulation of the heating capacity during the operation of the heat pump.

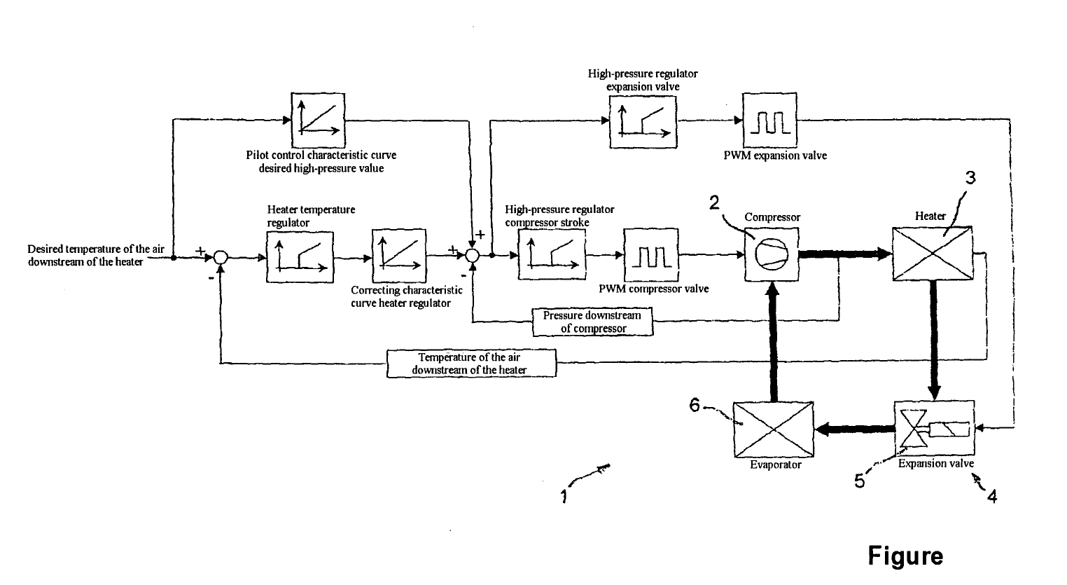

The invention relates to an air-conditioning system, in particular for a motor vehicle, according to the preamble of claim 1 and to a method for regulating the heating capacity thereof.

When an air-conditioning system is operating as a heat pump, a specific heating capacity is available in order to regulate the temperature of the air downstream of a heater. In this case, the temperature of the heater can be regulated by presetting a specific high pressure. For reasons of stability and dynamics, cascaded heater regulations, that is to say heater regulators with a subordinate high-pressure regulator, are often used in order to achieve the desired heating capacity. Regulation of this type, however, still leaves much to be desired.

The object of the invention is to make an improved air-conditioning system available.

This object is achieved by means of an air-conditioning system having the features of claim 1. Advantageous refinements are the subject matter of the subclaims.

According to the invention, an air-conditioning system, in particular a motor vehicle air-conditioning system, which can be operated as a heat pump, with a heater, with a throttle member, with an evaporator and with a compressor is provided, the compressor having a variable stroke and, as a result, heat-pump operation and, in particular, the temperature of the air downstream of the heater being regulatable. In this case, in particular the throttle member, which is designed as a regulatable expansion valve, contributes to regulating the heating capacity in heat-pump operation. By the heating capacity being regulated with the aid of an expansion valve and a variable compressive stroke, a markedly improved regulation of the heating capacity of an air-conditioning system in heat-pump operation is achieved.

The expansion valve preferably follows the heater and precedes the evaporator in the heat-pump circuit.

Regulation is carried out with the aid of a regulator for the stroke of the compressor. Preferably, a high-pressure regulator, in conjunction with a compressor valve, is provided for regulating the compressor and/or a high-pressure regulator is provided for regulating the expansion valve.

The expansion valve is preferably formed by an expansion valve regulated by means of a pulse-width modulated signal.

The regulation of the heating capacity of the air-conditioning system in heat-pump operation takes place preferably as a function of the desired temperature of the air downstream of the heater, taking into account a pilot control characteristic curve of a desired high-pressure value. In this case, the regulation of the heater temperature of the air-conditioning system in heat-pump operation takes place as a function of the desired temperature of the air downstream of the heater, taking into account the determined temperature of the air downstream of the heater, a correcting characteristic curve being taken into account.

Furthermore, preferably, the pressure of the refrigerant present in the heat-pump circuit, downstream of the compressor, is taken into account.

The invention is explained in detail below by means of an exemplary embodiment, with reference to the drawing. In the drawing, the single FIGURE shows a block diagram which illustrates the regulation according to the invention.

A heat-pump circuit 1 of the air-conditioning system is illustrated diagrammatically, in heat-pump operation, in the right lower part of the FIGURE, a refrigerant contained in the heat-pump circuit 1 being compressed by a compressor 2 with a variable stroke, subsequently being supplied to a heater 3, in which it discharges heat into the vehicle interior, thereafter expanding in a throttle member 4, in the present case an expansion valve 5 regulated via a pulse-width modulated signal (PWM), then being supplied to an evaporator 6 in which it absorbs heat, and being supplied to the compressor 2 again.

The regulation of the heat-pump circuit 1 in order to achieve a predetermined desired temperature of the air downstream of the heater 3 takes place as illustrated in the FIGURE.

In this case, the pressure in the heat-pump circuit 1 is regulated as a function of a pilot control characteristic curve of the desired high-pressure value, taking into account the current pressure downstream of the compressor 2, measured by a pressure sensor, not illustrated, with the aid of a high-pressure regulator which regulates the stroke of the compressor 2 via a compressor valve (PWM compressor valve) regulated by means of a pulse-width modulated signal. Furthermore, a corresponding pulse-width modulated regulation of the expansion valve 5 (PWM expansion valve) takes place via a high-pressure regulator of the expansion valve 5.

Furthermore, both in the regulation of the stroke of the compressor 2 and in the regulation of the expansion valve 5, the temperature of the heater 3 is taken into account by means of a heater temperature regulator, taking into account a correcting characteristic curve of the heater regulator, as a function of the temperature of the air downstream of the heater 3 determined by means of a temperature sensor, not illustrated. The regulation of the temperature or capacity of the heater 3 thus takes place by means of the compressor 2 and the expansion valve 5.

### LIST OF REFERENCE SYMBOLS

1 Heat-pump circuit
2 Compressor
3 Heater
4 Throttle member
5 Expansion valve
6 Evaporator

1. An air-conditioning system, in particular a motor vehicle air-conditioning system, which can be operated as a heat pump, with a compressor, with a heater, with a throttle member and with an evaporator, wherein the compressor has a variable stroke and the throttle member is designed as a controllable expansion valve which contributes to regulating the heating capacity in heat-pump operation.

2. The air-conditioning system as claimed in claim 1, wherein the expansion valve follows the heater and precedes the evaporator.

3. The air-conditioning system as claimed in claim 1, wherein a high-pressure regulator, in conjunction with a compressor valve, is provided for regulating the compressor.

4. The air-conditioning system as claimed in claim 1, wherein a high-pressure regulator is provided for regulating the expansion valve.

5. The air-conditioning system as claimed in claim 1, wherein the expansion valve is a pulse-width modulated expansion valve.

6. A method for regulating an air-conditioning system, in particular a motor vehicle air-conditioning system, which can be operated as a heat pump, with a compressor, with a heater, with a throttle member and with an evaporator, wherein regulation is carried out with the aid of a regulator for the stroke of the compressor, and the stroke of the compressor is carried out by means of a high-pressure regulator, in conjunction with the regulation of a compressor valve forming the throttle member.

7. The method as claimed in claim 6, wherein regulation is carried out as a function of a regulation of a pulse-width modulated expansion valve forming the throttle member, a high-pressure regulator being provided for this purpose.

8. The method as claimed in claim 6, wherein the regulation of the air-conditioning system in heat-pump operation takes place as a function of the desired temperature of the air downstream of the heater, taking into account a pilot control characteristic curve of a desired high-pressure value.

9. The method as claimed in claim 6, wherein the regulation of the heater temperature of the air-conditioning system in heat-pump operation takes place as a function of the desired temperature of the air downstream of the heater, taking into account the determined temperature of the air downstream of the heater, a correcting characteristic curve being taken into account.

10. The method as claimed in claim 6, wherein the regulation of the air-conditioning system in heat-pump operation takes place, taking into account the pressure of the refrigerant present in the heat-pump circuit, downstream of the compressor.
